(19) United States
(12) Patent Application Publication
(10) Pub. No.: US 2002/0123976 A1
(43) Pub. Date: Sep. 5, 2002

(54) Method and system for portfolio analysis and decision support using polar area graphs

(76) Inventor: David J.P. Baar, Vancouver (CA)

Correspondence Address: FASKEN, MARTINEAU DuMOULIN LLP, Suite 4200, Toronto-Dominion Bank Tower, Box 20, Toronto, ON, M5K 1N6, CA

(21) Appl. No.: 09/956,241

(22) Filed: Sep. 20, 2001

(30) Foreign Application Priority Data
Sep. 20, 2000 (CA) 2,320,615

(51) Int. Cl. G06F 17/20

(52) U.S. Cl. 706/11

(57) ABSTRACT

In a data processing system that executes a program of instructions, a method for displaying decision options for use in decision making on a display screen of a computer. The method comprises the steps of: displaying a polar graph on a display screen, wherein the polar graph has a plurality of sectors representing a plurality of decision criteria determinative of the decision option, and wherein each sector consists of a part of the polar graph bounded by two radii and a line segment subtended by the two radii, and wherein the importance of a decision criterion to the decision option is indicated by the angle between the radii forming the sector of the polar graph corresponding to the decision criterion, and wherein the merit of a decision criterion is indicated by the area of the sector corresponding to the decision criterion, and wherein the merit of the decision option is indicated by the total area of the plurality of sectors; calculating the merit of the decision option; and, displaying the merit of the decision option on the display screen, thereby enabling a user to make a decision concerning the decision option. A data processing system, computer program product, and integrated circuit product are provided wherein each has stored therein sequences of instructions which when executed cause the method described to be performed.

The invention relates to the field of data analysis, decision support, and computer graphics. More specifically, the invention relates to portfolio analysis and decision support using polar area diagrams, such as rose graphs.

### BACKGROUND OF THE INVENTION

Over the years, people have endeavoured to present information in ways that support effective decision-making. For example, in her 1858 work, “Notes on Matters Affecting the Health, Efficiency and Hospital Administration of the British Army”, Florence Nightingale presented a polar-area graph to present statistics relating to the death of British soldiers both in Battle and non-battle situations. This graph consists of a number of equal angle segments, in which the radius of respective segments is varied in relation to a value ascribed to the criteria being evaluated. This graph has become known as a “coxcomb” graph and was entitled “The Causes of Mortality in the Army in the East” and is illustrated in FIG. 7. The graph illustrates that most soldier fatalities during the period of the Crimean war were from preventable disease rather than from battlefield wounds and was used to affect government decision making around soldier hygiene. Here, frequency of deaths (i.e. number of deaths per month) is proportional to the area of the corresponding segment and each of the angles of the segments is constant (i.e. one for each month). Thus, the frequency of death is proportional to the square of the radius of the segment. Deaths due to each factor being considered are usually indicated by different colours within a given segment or sector. One of the limitations of this type of graphical representation is that comparisons can only be done within a given sector, thus only one type of factor (e.g. cause of death) can be represented.

The coxcomb diagram is different to standard pie-graphs in which the area of a segment (proportional to angle) generally represents the weighting of particular criteria with respect to all others as represented by 100% of the pie, and the radial distance is not utilized in the representation. The pie chart has limited application to complex decision making.

Techniques have evolved for presenting information via computer graphics with a view to decision support. Many of these techniques pertain to financial data, portfolio analysis, and related decision-making. Others pertain to general decision-making.

U.S. Pat. No. 6,195,643 (Maxwell) describes a bar-graph based output for a decision making system. In U.S. Pat. No. 6,115,691 (Ulwick), bar graphs are also described as the output of a system and method for evaluating and optimizing personal and business strategies.

U.S. Pat. No. 6,161,098 (Wallman) describes a two-dimensional line graph system that enables an investor with a portfolio of securities to manage taxable events created by trading securities in the portfolio. This type of graphical display presents a limited range of decision variables to the user. In U.S. Pat. No. 6,154,731 (Monks, et al.), a similar two-dimensional line graph is described that may be used for corporate governance related decisions.

In U.S. Pat. No. 6,088,688, utility resource usage information (e.g. electricity, gas, water, etc.) to facilitate decision making (simple pie, bar, or line graphs) are used to illustrate. In U.S. Pat. No. 5,884,287 (Edesess), for generating and displaying risk and return in an investment portfolio (displays multiple scenarios using area graphs or unique teardrop shaped graphics).

A need therefore exists for a method and system that will allow for the effective presentation of information to support decision-making. In particular, none of the current graphical representation diagrams are suitable for efficiently representing multiple decision criteria having different weights within a given portfolio of decision options, and which clearly displays strengths and weaknesses of particular choices to facilitate selection of the best choices.

### SUMMARY OF THE INVENTION

The method comprises the steps of: displaying a polar graph on a display screen, wherein the polar graph has a plurality of sectors representing a plurality of decision criteria determinative of the decision option, and wherein each sector consists of a part of the polar graph bounded by two radii and a line segment subtended by the two radii, and wherein the importance of a decision criterion to the decision option is indicated by the angle between the radii forming the sector of the polar graph corresponding to the decision criterion, and wherein the merit of a decision criterion is indicated by the area of the sector corresponding to the decision criterion, and wherein the merit of the decision option is indicated by the total area of the plurality of sectors; calculating the merit of the decision option; and, displaying the merit of the decision option on the display screen, thereby enabling a user to make a decision concerning the decision option.

According to another aspect of the invention, a method is provided wherein the line segment for each sector is shaped to form a smooth curve connecting adjacent sectors.

According to another aspect of the invention, a data processing system is provided. This data processing system has stored therein data representing sequences of instructions which when executed cause the above-described method to be performed. The data processing system generally has an input device, a central processing unit, memory, and a display.

According to another aspect of the invention there is provided a computer software product comprising a sequences of instructions which when executed cause the above-described method to be performed.

According to another aspect of the invention there is provided an integrated circuit product comprising a sequences of instructions which when executed cause the above-described method to be performed.

### BRIEF DESCRIPTION OF THE DRAWINGS

The invention may best be understood by referring to the following description and accompanying drawings wherein:

FIG. 1 is a screen capture illustrating a rose graph in accordance with a preferred embodiment;

FIG. 2 is a diagram illustrating the rose graph of FIG. 1 wherein the weight of a group of decision criteria has been doubled;

FIG. 3 is a diagram illustrating the rose graph of FIG. 2 wherein the weight of a decision criterion within a group of decision criteria has been increased five fold;

FIG. 4 is a diagram illustrating the rose graph of FIG. 3 showing failed decision criteria within groups of decision criteria;

FIG. 5 is a flow chart illustrating a method for portfolio analysis and decision support using rose graphs in accordance with the preferred embodiment;

FIG. 6 is a block diagram illustrating an exemplary data processing system in accordance with the preferred embodiment; and

FIG. 7 is a diagram illustrating a “coxcomb” graph in accordance with the prior art.

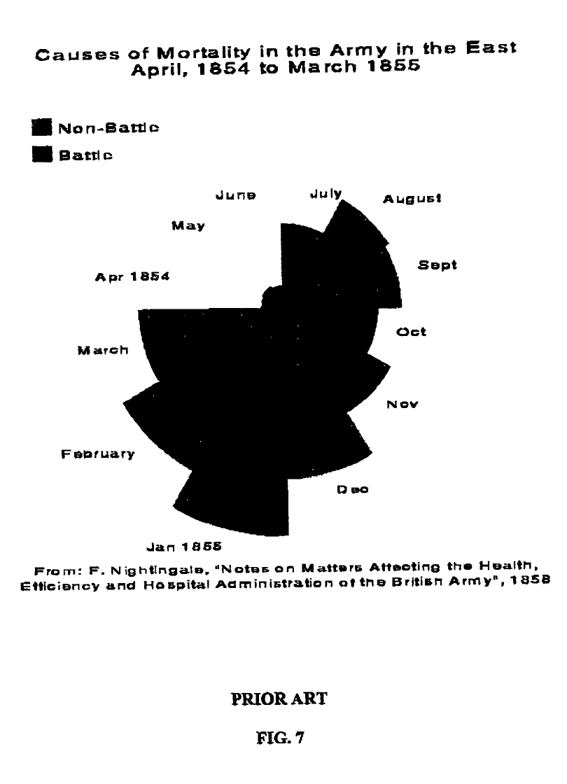

### DETAILED DESCRIPTION OF THE PREFERRED EMBODIMENTS

In the following description, numerous specific details are set forth to provide a thorough understanding of the invention. However, it is understood that the invention may be practiced without these specific details. In other instances, well-known software, circuits, structures and techniques have not been described or shown in detail in order not to obscure the invention. The term data processing system is used herein to refer to any machine for processing data, including the computer systems and network arrangements described herein. In the drawings, like numerals refer to like structures or processes.

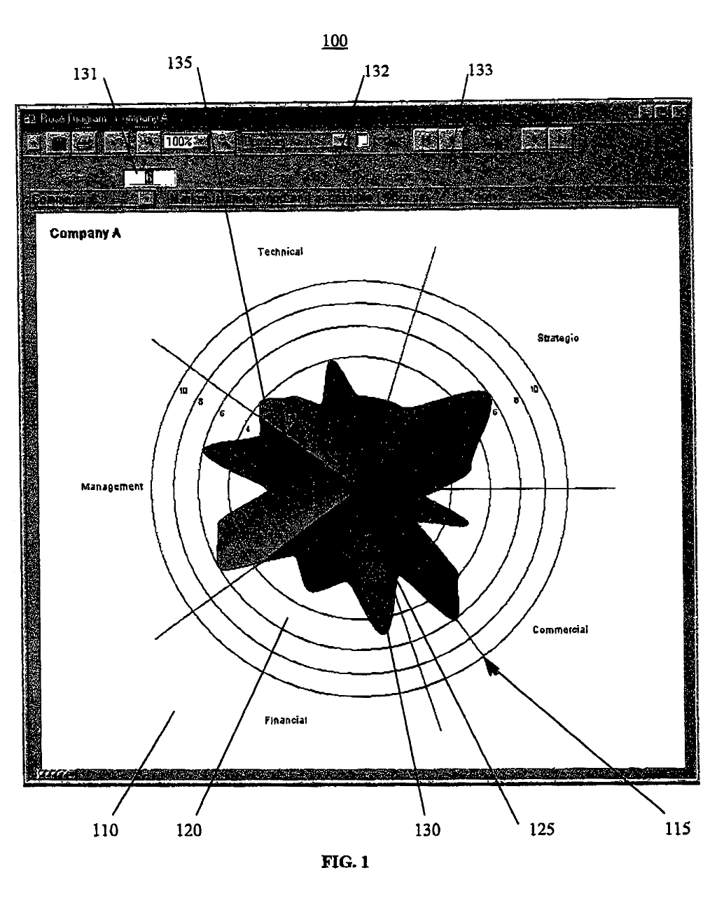

Referring to FIG. 1 there is shown a polar area diagram 110, according to an embodiment of the present invention, for use in a graphical system for presenting a plurality of relatively weighted criteria impacting a decision option. The polar area diagram comprises a plurality of sectors each representing one of a plurality of decision criteria determinative of the decision option, each sector consists of an area bounded by two radii and a line segment subtended by the two radii. A plurality of concentric circles centred about the origin of the polar area diagram correspond to scores of the relative merit for that option. Each sector 130 of the graph 110 represents either a single criterion (or sub-criterion) 130 within a given decision or a grouping 120 or hierarchy or category of such criteria. The merit of a given choice in a multiple-choice decision with respect to a particular criterion is illustrated by the area of a graph sector 130 such that the relative merit is directly related to the area of the sector 130 by a monotonic “scoring” function. The relative importance of a given criterion or group of criteria is criterion is illustrated by the angle 125 subtended by the corresponding graph sector 130 or sector group 120 such that the relative importance is directly related to the angle of the sector 130 or sector group 120 by a monotonic “weighting” function. This function may be a proportionality function. A specific choice is ranked among a set of possible choices by a calculation of the area contained within the corresponding rose graph 110, or by a direct calculation using the scoring and weighting functions, Sector 131, group 132, and overall 133 scores may be presented to the user along with the graph. Group scores are computed as a weighted average of the scores of the criteria within that group. Overall scores are calculated as the weighted average of the group scores. Similar criteria or sets of criteria or criteria groups may be represented with the same colour (hue) but with different intensity (saturation) to allow the user to visibly distinguish between criteria. And, different criteria groups may be shown with different colours (hues). In addition, to aid users in seeing trends within a given decision option, a method of curve fitting (e.g. a cubic spline fit) may be used to smoothly connect adjacent sectors. Such a curve 135 is illustrated in FIG. 1.

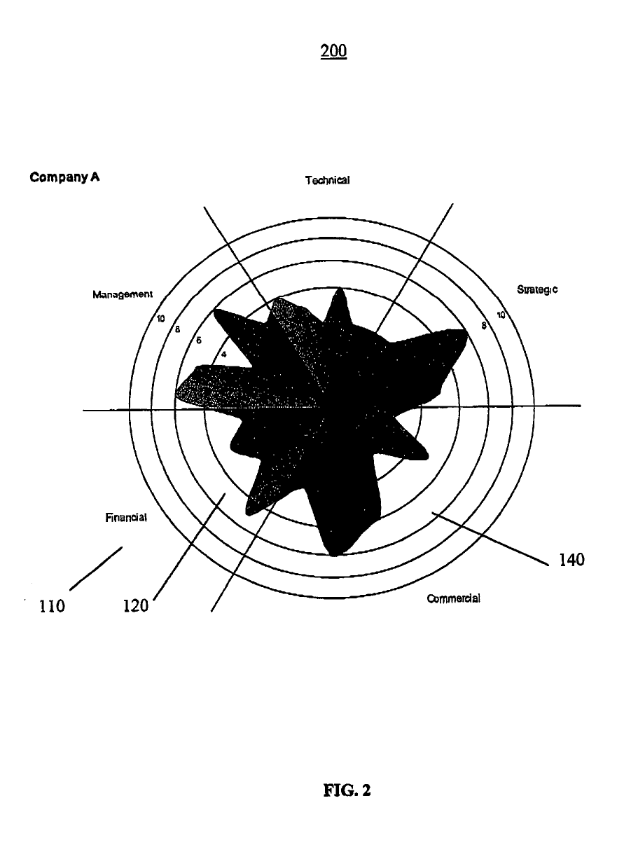

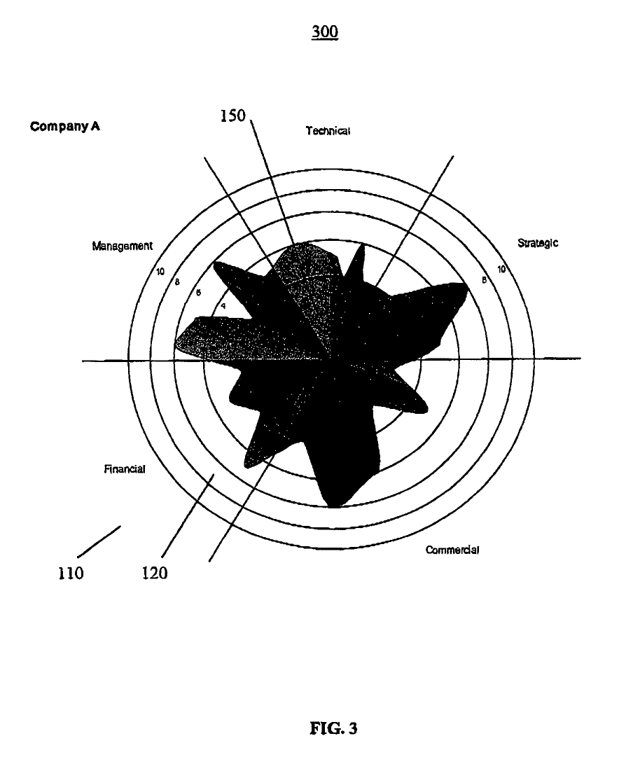

Referring to FIG. 2, and in accordance with the preferred embodiment, there is shown a diagram 200 illustrating the rose graph 110 of FIG. 1 wherein the relative weight of a group of decision criteria (e.g. the “Commercial” group of criteria) has been doubled. That is, the angle subtended by the group of sectors 140 corresponding to the group of decision criteria has been doubled in FIG. 2. Referring to FIG. 3, and in accordance with the preferred embodiment, there is shown a diagram 300 illustrating the graph 110 of FIG. 2 wherein the weight of a decision criterion within a category of decision criteria has been increased five fold. That is, the angle subtended by the sector 150 corresponding to the decision criterion has been increased five fold in FIG. 3.

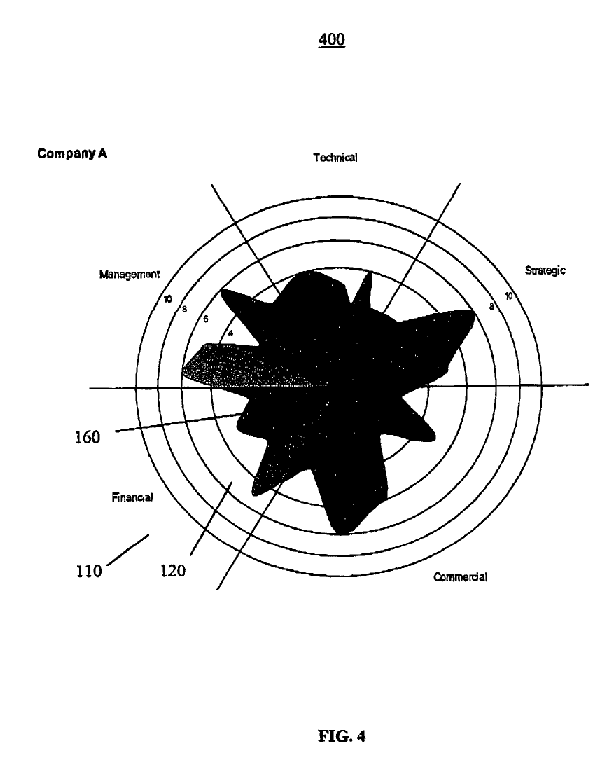

Specific colours may be used to highlight criteria for which a given option does not meet a minimum degree of merit. For example, a sector may be coloured red if it does not meet a given degree of merit. As such, colours may be used to indicated pass and fail status. Referring to FIG. 4, there is shown a diagram 400 illustrating the graph 110 of FIG. 3 wherein “failed” decision criteria 160 have been shaded in accordance with the preferred embodiment.

The state of a particular graph at any point in time can be saved by the user. This allows a history of rose graphs to be produced for monitoring the progress of a choice over time. For example, this allows for the monitoring of changes in employee performance or investment performance over time.

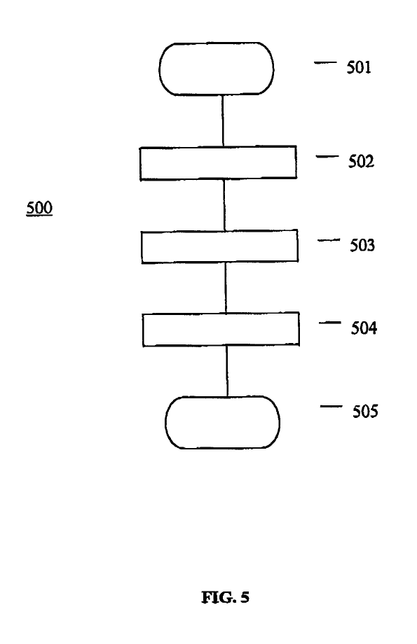

Referring to FIG. 5, there is shown a flow chart 500 illustrating an application of the graphic system to portfolio analysis and decision support. In this example, it is assumed that we wish to evaluate a particular company, Company A on a number of categories of criteria such as management, financial, commercial, strategic and technical. Each of these categories may have a number of sub-categories or criterion. Associated with each of the categories and criterion are values all of which may be stored in a relational database. An example of this data is shown in Table I. At a first Step 501, a selection of the option to profile is made. In this case, Company A is made, along with the relevant categories and criteria in evaluating this option. Next at Step 502, the relative weights of the is obtained (category weight column) and a polar graph is generated with a sector given to each of the categories. The angle of each of the category sectors is proportional to their respective relative weights. Next at a Step 503, the weights of each of the criterion within a specified category is obtained and based on the relative importance of each of the criterion to the other criteria an angle for that criterion is generated and displayed. Thus the relative importance of a given criterion is directly related to the angle of the sector by a monotonic weighting function. Next at Step 504, the merit of a given sub-criteria indicated by a particular value (score) is obtained and is used to compute the radii of the line segment subtending that criterion's segment. Finally at Step 505, the areas (proportional to a square of a radius x the angle in radians) of the various sectors are highlighted by a predetermined colour, the choice of which is described earlier.

Accordingly, it may be seen in each sector has a score and the weighted average of all scores in the sector group (category) gives a category group score. This is done for each category. As observed in Table I, each category has a weight and thus the weighted average of the category scores is computed to generate an overall score for the option.

The method as described above may be easily implemented as a sequence of instructions in one or more programming languages.

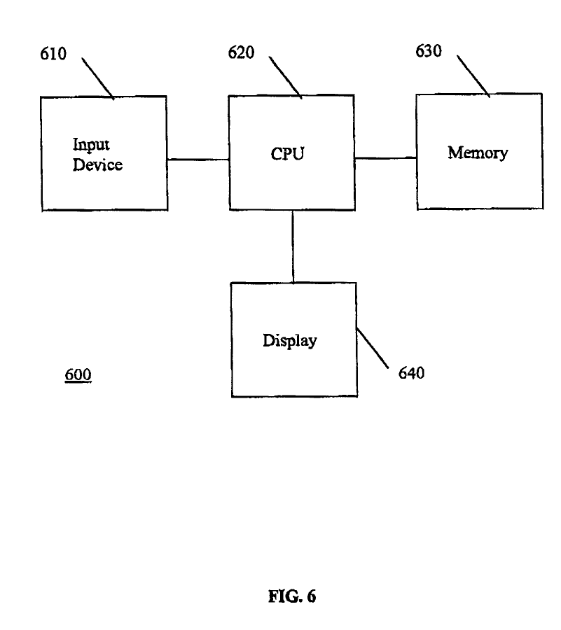

Referring to FIG. 6, there is shown a block diagram of an exemplary data processing system 600 according to one embodiment of The invention. The data processing system 600 is suitable for portfolio analysis and decision support using rose graphs. The data processing system 600 includes an input device 610, a central processing unit or CPU 620, memory 630, and a display 640. The input device 610 may be a keyboard, mouse, trackball, or similar device. The CPU 620 may include dedicated coprocessors and memory devices. The memory 630 may include RAM, ROM, databases, or disk devices. And, the display 640 may include a computer screen or terminal device. The data processing system 600 has stored therein data representing sequences of instructions which when executed cause the method described herein to be performed. Of course, the data processing system 600 may contain additional software and hardware a description of which is not necessary for understanding the invention.

Referring to FIGS. 1 and 6, an interactive user interface may be implemented using a data processing system 600 such that “hovering” a cursor 115 positioned by an input device 610 over a particular sector 130 of a rose graph 110 causes the text of the associated criterion to be presented on a display 640. The text of the associated criterion may be stored in a database 630. In addition, by “clicking” an input device 610 while the cursor 115 is positioned over a particular sector 130 enables editing of the attributes for that sector 130 including the relative merit of the criterion associated with the sector.

Computer Software Product. The sequences of instructions which when executed cause the method described herein to be performed by the exemplary data processing system of FIG. 6 can be contained in a computer software product according to one embodiment of the invention. This computer software product can be loaded into and run by the exemplary data processing system of FIG. 6.

Integrated Circuit Product. The sequences of instructions which when executed cause the method described herein to be performed by the exemplary data processing system of FIG. 6 can be contained in an integrated circuit product including a coprocessor or memory according to one embodiment of the invention. This integrated circuit product can be installed in the exemplary data processing system of FIG. 6.

In summary the polar are graph of the present invention is able to represent categories of information having differing numbers of criteria within each category and also allows graphical representation of the weighting of the different categories and/or criteria.

Furthermore, the present invention, through a computer graphics implementation of a “rose” graph, which is coupled to a relational database of decision criteria enables portfolio analysis and decision support by allowing users to visually compare choices available within a portfolio of decision options. According to the preferred embodiment, a single rose graph is used to represent each decision option. Both the relative merit of that option for each given criterion, and the relative importance or weighting of each criterion are shown graphically. The graphical representation thus illustrates strengths and weaknesses of particular potential choices and facilitates the selection of the best choice. A scoring method may be used to rank the decision options and additional graphical reports consisting of composite rose diagrams and other graph types can be used to illustrate the results. The present invention may be applied to business decision-making in areas such as investment portfolio analysis, purchasing decisions, hiring decisions, employee performance analysis, human resources, customer satisfaction surveys (i.e. customer relationship management), and general business strategy decisions.

Although the invention has been described with reference to certain specific embodiments, various modifications thereof will be apparent to those skilled in the art without departing from the spirit and scope of the invention as outlined in the claims appended hereto.

TABLE I

| Profile | Category | Criterion | Score | Weight | category Wght |
|---|---|---|---|---|---|
| Company A | Commercial | Are alternative/competing technologies a threat (10 = no/1 = yes) | 5 | 1 | 1 |
| Company A | Commercial | Degree to which sufficient market share can be captured | 6 | 2.5 | 1 |
| Company A | Commercial | Early adopters or key market accounts exist (10 = yes/1 = no) | 4 | 1 | 1 |
| Company A | Commercial | First to market (10 = yes/1 = market is crowded with similar products) | 9 | 1.7 | 1 |
| Company A | Commercial | Market is understood and accessible (10 = yes/1 = no) | 9 | 1 | 1 |
| Company A | Commercial | Partnering networks with sources of venture funding (10 = high/1 = | 9 | 1 | 1 |
| | | low) | | | |
| Company A | Financial | Certainty of return/profit estimates (10 = high/1 = low) | 7 | 0.7 | 1.2 |
| Company A | Financial | How much financial commitment is necessary to bring the technology to | 9 | 1 | 1.2 |
| | | market (10 = small commitment/1 = large commitment) | | | |
| Company A | Financial | The investment is attractive to venture financiers (10 = yes/1 = no) | 8 | 1 | 1.2 |
| Company A | Management | Critical technical skills are available in the work force or subcontractors | 4 | 1 | 1 |
| | | (10 = high/1 = low) | | | |
| Company A | Management | Strategic Planning - degree to which a credible Business Plan exists (10 = | 5 | 1 | 1 |
| | | high/1 = low) | | | |
| Company A | Management | Suitable supporting infrastructure is available (10 = high/1 = low) | 6 | 1 | 1 |
| Company A | Management | The principals are credible and “saleable” on their own right (10 = yes/1 = | 6 | 1 | 1 |
| | | no) | | | |
| Company A | Management | The principals are seriously committed to the undertaking (10 = yes/1 = | 9 | 1 | 1 |
| | | no) | | | |
| Company A | Strategic | Size of market (10 = large and expanding/1 = small and declining) | 10 | 1.4 | 1 |
| Company A | Strategic | Time to Market - how fast (10 = fast/1 = slow) | 6 | 1 | 1 |
| Company A | Strategic | Will a licensee or other investor find this technology more attractive than | 7 | 1 | 1 |
| | | other investments? (10 = yes/1 = no) | | | |
| Company A | Technical | Appropriateness for patent protection (5 = strong patent position/ | 9 | 1 | 1 |
| | | 1 = weak patent position) | | | |
| Company A | Technical | Degree to which inventor is a “team player” (10 = high/1 = low) | 8 | 1 | 1 |
| Company A | Technical | Is there clear ownership of the technology (Intellectual property) | 9 | 1 | 1 |
| Company A | Technical | Multiple fields of use (i.e. enabling characteristics) (10 = yes/1 = no) | 7 | 1 | 1 |
| Company A | Technical | Proof of concept can easily be demonstrated with a prototype (10 = easy | 9 | 1 | 1 |
| | | to demonstrate/1 = not easy to demonstrate) | | | |
| Company A | Technical | State-of-the-art technology (10 = high tech/1 = low tech) | 8 | 1 | 1 |

The embodiments of the invention in which an exclusive property or privilege is claimed are defined as follows:

1. In a data processing system that executes a program of instructions, a method for displaying decision options for use in decision making on a display screen of a computer, comprising the steps of:
a) displaying a polar graph on said display screen, wherein said polar graph has a plurality of sectors representing a plurality of decision criteria determinative of said decision option, and wherein each said sector consists of a part of said polar graph bounded by two radii and a line segment subtended by said two radii, and wherein the importance of a decision criterion to said decision option is indicated by the angle between the radii forming the sector of said polar graph corresponding to said decision criterion, and wherein the merit of a decision criterion is indicated by the area of the sector corresponding to said decision criterion, and wherein the merit of said decision option is indicated by the total area of said plurality of sectors;
b) calculating said merit of said decision option; and,
c) displaying said merit of said decision option on said display screen, thereby enabling a user to make a decision concerning said decision option.

2. The method of claim 1 wherein said polar graph is a rose graph.

3. The method of claim 1 wherein said line segment for each said sector is shaped to form a smooth curve connecting adjacent sectors.

4. The method of claim 3 wherein said smooth curve is produced by a spline fit algorithm.

5. The method of claim 4 wherein said spline fit algorithm is cubic.

6. The method of claim 1 wherein ones of said sectors are grouped adjacently to form sector categories corresponding to categories of criteria.

7. The method of claim 6 wherein said categories of criteria consist of related criteria.

8. The method of claim 6 wherein each said sector category is displayed in one colour.

9. The method of claim 8 wherein each said sector of each said sector category is displayed with a different intensity of said one colour.

10. A data processing system for displaying decision options for use in decision making including an input device, a central processing unit, memory, and a display wherein said data processing system has stored therein data representing sequences of instructions which when executed cause the method and use of claims 1 through 9 to be performed.

11. A computer software product containing sequences of instructions which when executed cause the method and use of claims 1 through 9 to be performed.

12. An integrated circuit product containing sequences of instructions which when executed cause the method and use of claims 1 through 9 to be performed.
